(19) United States
(12) Patent Application Publication
(10) Pub. No.: US 2021/0309544 A1
(43) Pub. Date: Oct. 7, 2021

(54) NITRATE REMOVAL FROM WATER BODIES USING ELECTROCATALYTIC HYDROGEN EVOLUTION AND CATALYTIC HYDROGENATION

(71) Applicant: Tongji University, Shanghai (CN)

(72) Inventors: Jianwei FAN, Shanghai (CN); Zhangqiang HU, Shanghai (CN); Weixian ZHANG, Shanghai (CN); Xianqiang RAN, Shanghai (CN); Wei TENG, Shanghai (CN)

(73) Assignee: Tongji University, Shanghai (CN)

(21) Appl. No.: 17/004,038

(22) Filed: Aug. 27, 2020

(30) Foreign Application Priority Data
Apr. 3, 2020 (CN) 202010257438.3

(51) Int. Cl. C02F 1/467; C02F 1/461

(52) U.S. Cl. CPC C02F 1/4676; C02F 2103/007; C02F 1/46109

(57) ABSTRACT

A denitrification system for removing nitrates in a water body by electrocatalytic hydrogen evolution and catalytic hydrogenation is disclosed. The denitrification system includes an electrolytic cell and a three-electrode system inserted into the electrolytic cell. The electrolytic cell contains electrolyte solution, and the denitrification catalyst is dispersed and suspended in the electrolyte solution. The three-electrode system includes a working electrode, a counter electrode and a reference electrode. The counter electrode adopts Pt sheet, the working electrode adopts the catalyst Ni₃S₂—NF, and the preparation steps of the catalyst Ni₃S₂—NF are as follows: (i) cutting a certain size nickel mesh and cleaning it; (ii) adding the cleaned nickel mesh into thiourea solution; (iii) reacting under hydrothermal conditions, and washing and drying to obtain the catalyst Ni₃S₂—NF. The invention avoids the hazards of storing and transporting hydrogen storage and realizes the efficient removal of nitrate in water by electrocatalytic hydrogen evolution and catalytic hydrogenation.

### CROSS REFERENCE TO THE RELATED APPLICATIONS

This application is based upon and claims priority to Chinese Patent Application No. 202010257438.3, filed on Apr. 3, 2020, the entire contents of which are incorporated herein by reference.

### TECHNICAL FIELD

The invention relates to water treatment, and more particularly, to a denitrification system for removing nitrates in a water body by electrocatalytic hydrogen evolution and catalytic hydrogenation.

### BACKGROUND

Nitrate is a common pollutant in water. Factors that cause the nitrate content to exceed regulatory standards include (i) the ubiquitous use of nitrogen containing fertilizer in agriculture, (ii) leaching and leakage of animal manure and solid waste, (iii) random discharge of domestic sewage and industrial wastewater containing nitrogen and (iv) atmospheric deposition of nitrogen oxides from industrial waste gas and automobile exhaust. Excessive nitrate in rivers and lakes causes eutrophication of the water body. In drinking water, it can be hazardous to health. Too much nitrate in drinking water is known to cause blue baby syndrome, methemoglobin syndrome and other health related conditions. Over time, it may cause cancer.

At present, methods for removing nitrate from water mainly include physical methods, such as ion exchange, reverse osmosis and electrodialysis, biological methods and chemical methods. Physical methods do not actually remove or transform nitrate into a harmless substances. Instead, physical processes transfer nitrate from an aqueous phase to an adsorbent, so the physical processes, like reverse osmosis, does not really solve the problem of nitrate pollution. Biological methods require strict control of pH, dissolved oxygen or carbon sources. Chemical methods include active metal reduction, electrochemical reduction and catalytic hydrogenation reduction. Specifically, the active metal reduction requires a strict pH control to prevent active metal passivation, and nitrite and ammonia nitrogen are the main products of reaction. Electrochemical reduction has gained attention in recent years because there is little-to-no biological risk or hydrogen transportation and storage problems. The majority of its products, however, are ammonia and nitrogen. Additionally, the denitrification rate using electrochemical reduction is quite low. The catalytic hydrogenation reduction has a high denitrification rate and is highly selective to nitrogen, but transporting and storing of hydrogen, which is the reducing agent used in the reaction is extremely dangerous and so, its industrial application has been limited.

### SUMMARY

To address the problems in the prior art, the invention provides a denitrification system that can efficiently remove nitrate from water by electrocatalytic hydrogen evolution and catalytic hydrogenation. The denitrification system has the functions of electrocatalytic hydrogen evolution and catalytic hydrogenation, which can not only avoid the hazards of storing and transporting hydrogen, but also realize the efficient removal of nitrate in water.

In order to realize the above technical purpose, the technical scheme of the invention is as follows:

A denitrification system for efficiently removing nitrate in a water body by electrocatalytic hydrogen evolution and catalytic hydrogenation includes an electrolytic cell and a three-electrode system inserted into the electrolytic cell. The electrolytic cell contains electrolyte, and the denitrification catalyst is dispersed and suspended in the electrolyte solution. The three-electrode system includes a working electrode, a counter electrode and a reference electrode, and the counter electrode adopts Pt sheet, the working electrode adopts the catalyst Ni₃S₂—NF, and the preparation steps of the catalyst Ni₃S₂—NF are as follows:

(1) cutting and cleaning a nickel mesh;

(2) adding the nickel mesh cleaned in step (1) into a thiourea solution, and then placing it under hydrothermal conditions;

(3) washing and drying the material obtained in step (2).

Preferably, the denitrification catalyst is an activated carbon PdCu-AC supported with metal palladium and copper, and the preparation steps of the PdCu-AC are as follows:

(1) adding an activated carbon into nitric acid, heating in water bath, filtering and drying to obtain a pretreated activated carbon AC;

(2) adding the pretreated AC, palladium chloride PdCl₂ and copper nitrate into ethanol and stirring evenly;

(3) stirring the mixture obtained in step (2) at room temperature until the ethanol is evaporated, and drying the mixture;

(4) calcining the powder obtained in step (3) in a tubular furnace to obtain the catalyst PdCu-AC.

Further preferably, the nitric acid in step (1) is 10-15% dilute nitric acid, a temperature of the water bath is 60-100° C., the heating lasts for 4-6 h, a vacuum suction filtration is used for filtration, and the drying is performed at 100-120° C. for 2-4 h.

Further preferably, the copper nitrate in step (2) is copper nitrate trihydrate Cu(NO₃)₂.3H₂O, and a mass ratio of AC, PdCl₂ and Cu(NO₃)₂.3H₂O is 1: (0.0835-0.167):(0.0945-0.189).

Further preferably, the drying described in step (3) is performed in an oven at 60-100° C. for 10-12 h.

Further preferably, the calcining in step (4) is carried out in the tubular furnace under a nitrogen atmosphere for 2-4 h, in which the temperature is raised to 400° C. at a heating rate of 1° C./min.

Preferably, the cleaning method of the nickel mesh in step (1) is as follows: ultrasonic cleaning in 30 ml acetone and 30 ml hydrochloric acid for 10-15 min in turn, and then cleaning three times with ethanol and water, respectively.

Preferably, a concentration of the thiourea solution in step (2) is 0.10-0.20 M, the hydrothermal temperature is 120-150° C., and the hydrothermal time is 4-6 h.

Preferably, the washing method described in step (3) is to wash three times with ethanol, and the drying is vacuum drying at room temperature.

The application of the denitrification system in the removal of nitrate in water body is characterized in that the electrolyte solution is a solution containing sodium nitrate and sodium sulfate, a concentration of the sodium nitrate in the electrolyte solution is 100 mg-N/L, a concentration of the sodium sulfate is 0.1 M. and a denitrification catalyst is dispersed and suspended in the electrolyte solution, wherein, 1 g of the denitrification catalyst is dispersed and suspended in 100 ml of the electrolyte solution, an electrochemical workstation which is electrically connected to the three-electrode system is started for reaction for 5 h.

It can be seen from the above description that the invention has the following advantages:

The system of the invention first generates hydrogen through the hydrogen evolution reaction at the cathode, and the generated hydrogen is directly used as a reducing agent for catalytic reduction of nitrate. By suspending the denitrification catalyst in the electrolytic cell, the mass transfer effect between hydrogen and denitrification catalyst is increased, so that the denitrification system of the invention has the functions of electrocatalytic hydrogen evolution and catalytic hydrogenation, which can not only avoid the hazards of storing and transporting hydrogen, but also realize the efficient removal of nitrate in water.

### BRIEF DESCRIPTION OF THE DRAWINGS

FIG. 1 is a structural diagram of the denitrification system of the invention;

FIG. 2 is a transmission electron microscope (TEM) image of the denitrification chemical catalyst in embodiment 1;

FIG. 3 is a TEM image of the denitrification chemical catalyst in embodiment 2;

FIG. 4 is a TEM image of the denitrification chemical catalyst in embodiment 3;

FIG. 5 is a comparison diagram of denitrification effects in embodiments 1-3 and comparative example 1;

FIG. 6 is a diagram showing leaching percentage of the denitrification catalyst supported with metal during six regeneration cycles in embodiment 1;

FIG. 7 is a denitrification effect diagram of six regeneration cycles in embodiment 1; and

FIG. 8 is a comparison diagram of denitrification effects of embodiment 1 and comparative examples 1-2.

In the drawings:

1. electrolytic cell

11. denitrification catalyst

21. working electrode

22. counter electrode

23. reference electrode

3. electrochemical workstation

### DETAILED DESCRIPTION OF THE EMBODIMENTS

The features of the invention are further described through the implementation embodiments, but the claims of the invention are not limited.

### Embodiment 1

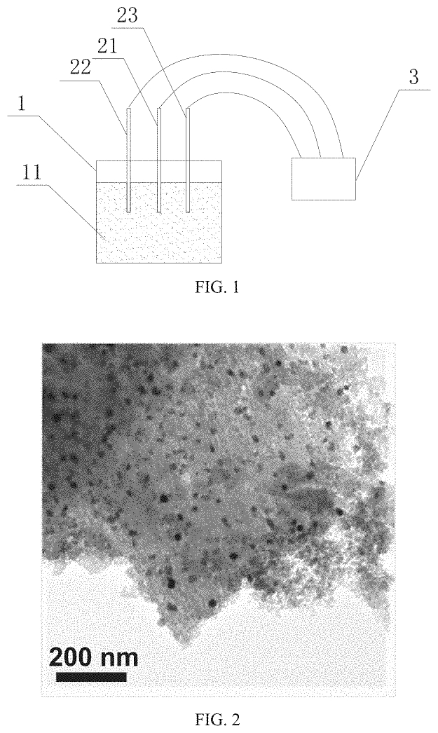

A denitrification system for efficiently removing nitrate in a water body by electrocatalytic hydrogen evolution and catalytic hydrogenation is provided. As shown in FIG. 1, the system includes the electrolytic cell 1 and a three-electrode system inserted into the electrolytic cell 1.

The electrolytic cell 1 contains electrolyte solution, and the denitrification catalyst 11 is dispersed and suspended in the electrolyte solution, and the denitrification catalyst 11 is an activated carbon PdCu-AC supported with metal palladium and copper, and the preparation steps of the PdCu-AC are as follows:

(1) 25 g of activated carbon powder is added to 500 ml of 10% dilute nitric acid, heated in a water bath at 80° C. for 4 h, and then filtered by vacuum suction filtration to obtain a solid, and finally the solid is put in an oven for drying at 100° C. for 4 h to obtain a pretreated AC;

(2) 0.0835 g of PdCl₂, 0.0945 g of Cu(NO₃)₂.3H₂O and 1 g of the pretreated AC are added into 10 ml of ethanol and stirred evenly;

(3) the mixture obtained in step (2) is stirred at room temperature until the ethanol is evaporated, and the obtained solid is dried in the oven at 80° C. for 12 h; and

(4) the product obtained in step (3) is placed in a tubular furnace, heated to 400° C. at a heating rate of 1° C./min under a nitrogen atmosphere and calcined for 2 h to obtain an activated carbon catalyst (5% PdCu-AC) supported with palladium and copper. The TEM image of the catalyst is shown in FIG. 2.

The three-electrode system includes the working electrode 21, the counter electrode 22 and the reference electrode 23. The counter electrode adopts Pt sheet. The working electrode 21 adopts the catalyst Ni₃S₂—NF, and the preparation steps of the catalyst Ni₃S₂—NF are as follows:

(1) a nickel mesh is cut to have a size of 2.5—2.5 cm, which is first ultrasonic cleaned with 30 ml of acetone for 10 min, and then cleaned using ultrasound with 30 ml of 3 M hydrochloric acid for 10 min, and finally washed with ethanol and deionized water for 3 times respectively;

(2) the cleaned nickel mesh in step (1) is added to 20 ml of 0.15M thiourea solution and transferred to a reactor, and kept airtight for 5 h at 150° C.;

(3) Ni₃S₂—NF is obtained by washing the material obtained in step (2) three times with ethanol and vacuum drying at room temperature.

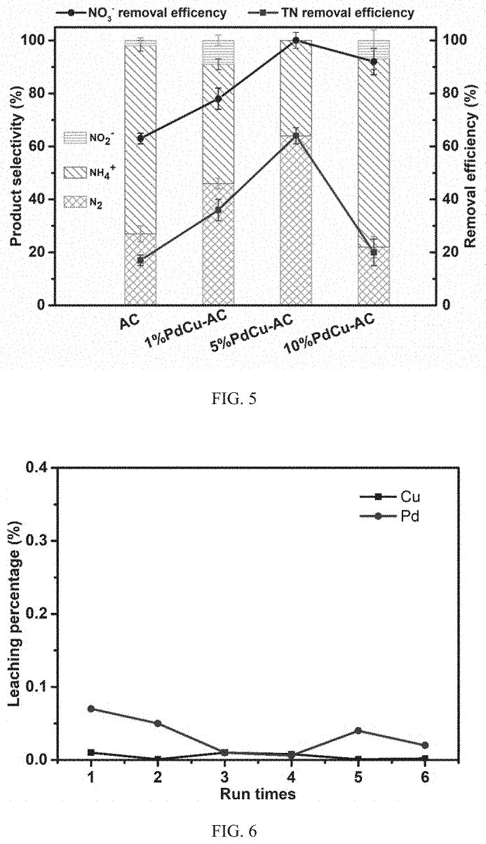

The above denitrification system is applied to the removal of nitrate in water, and the specific steps are as follows: 100 ml of solution containing sodium nitrate and sodium sulfate is used as electrolyte solution. The concentration of sodium nitrate in the electrolyte solution is 100 mg-N/L, and the concentration of sodium sulfate is 0.1 M. And 1 g of denitrification catalyst, i.e., 5% PdCu-AC prepared above, is suspended in the electrolyte solution. The electrochemical workstation CH1760D 3 electrically connected to the three-electrode system is engaged to perform the denitrification reaction for 5 h. The denitrification effect is shown in FIG. 5, wherein the abscissa of FIG. 5 shows the denitrification catalyst with different metal supporting contents. The left ordinate is the proportion of reaction products, and the right ordinate is the nitrate removal rate.

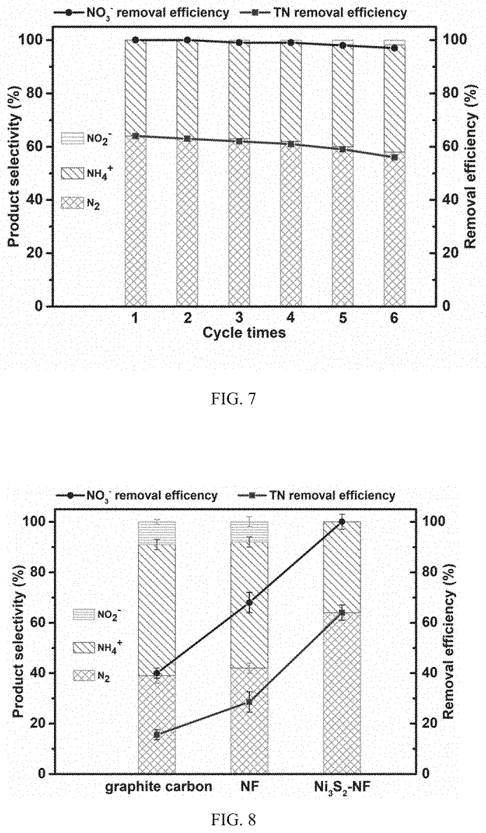

The 5% PdCu-AC denitrification catalyst after the denitrification reaction is recycled for repeatedly performing the above application operations 6 times. The metal content in the reaction solution during each reaction is tested for further analyzing the structural stability of the material. The result is shown in FIG. 6, and the denitrification effect of each reaction is shown in FIG. 7. The abscissa of FIG. 6 represents the reaction times, and the ordinate represents the precipitation percentage of metal Pd and Cu in the reaction solution. The abscissa of FIG. 7 shows the recycling times of denitrification catalyst: The left ordinate is the proportion of reaction products, and the right ordinate is the removal rate of nitrate. It can be seen from FIG. 6 that the metal content in the reaction solution remains low after six times of recycling, which indicates that the structure stability of the 5% PdCu-AC denitrification catalyst is high. FIG. 7 shows that the 5% PdCu-AC denitrification catalyst still has high denitrification effect after six times of recycling, which indicates that the structure stability of PdCu-AC denitrification catalyst is consistent with the denitrification effect stability thereof.

### Embodiment 2

A denitrification system for efficiently removing nitrate in a water body by electrocatalytic hydrogen evolution and catalytic hydrogenation includes the electrolytic cell 1 and a three-electrode system inserted into the electrolytic cell 1.

The electrolytic cell 1 contains electrolyte solution, and the denitrification catalyst 11 is dispersed and suspended in the electrolyte solution. The denitrification catalyst 11 is an activated carbon PdCu-AC supported with metal palladium and copper, and the preparation steps of the PdCu-AC are as follows:

(1) 25 g of activated carbon powder is added to 500 ml of 10% dilute nitric acid, heated in water bath at 80° C. for 4 h, and then filtered by vacuum suction filtration to obtain a solid, and finally the solid is put in an oven for drying at 100° C. for 4 h to obtain a pretreated AC;

(2) 0.0167 g of PdCl_{2,} 0.0189 g of Cu(NO₃)₂.3H₂O and 1 g of the pretreated AC are added into 10 ml of ethanol and stirred evenly;

(3) the mixture obtained in step (2) is stirred at room temperature until the ethanol is evaporated, and the obtained solid is dried in the oven at 80° C. for 12 h;

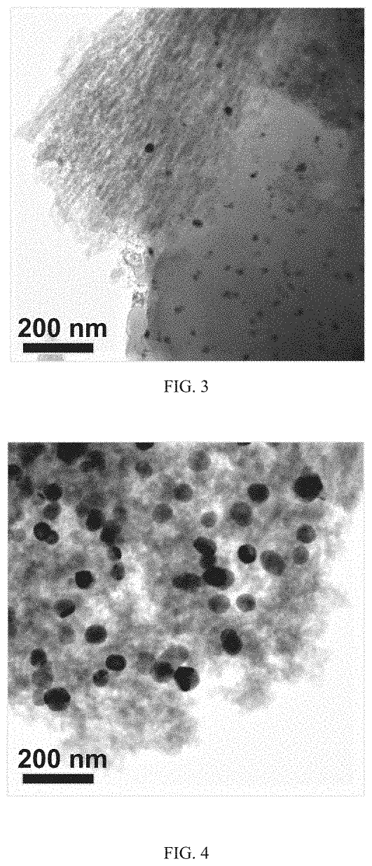

(4) the product obtained in step (3) is placed in a tubular furnace, heated to 400° C. at a heating rate of 1° C./min under a nitrogen atmosphere and calcined for 2 h to obtain an activated carbon catalyst (1% PdCu-AC) supported with palladium and copper. The TEM image of the catalyst is shown in FIG. 3.

The three-electrode system includes the working electrode 21, the counter electrode 22 and the reference electrode 23. The counter electrode 22 adopts Pt sheet, the working electrode 21 adopts the catalyst Ni₃S₂—NF, and the preparation steps of the catalyst Ni₃S₂—NF are as follows:

(1) a nickel mesh is cut to have a size of 2.5×2.5 cm, which is first ultrasonically cleaned with 30 ml of acetone for 10 min, and then cleaned using ultrasound with 30 ml of 3 M hydrochloric acid for 10 min, and finally washed with ethanol and deionized water for 3 times;

(2) the cleaned nickel mesh in step (1) is added to 20 ml of 0.15M thiourea solution and transferred to a reactor, and kept airtight for 5 h at 150° C.;

(3) Ni₃S₂—NF is obtained by washing the material obtained in step three tunes with ethanol and vacuum drying at room temperature.

The above denitrification system is applied to the removal of nitrate in water, and the specific steps are as follows: 100 ml of solution containing sodium nitrate and sodium sulfate is used as electrolyte solution. The concentration of sodium nitrate in the electrolyte solution is 100 mg-N/L, and the concentration of sodium sulfate is 0.1 M, and 1 g of denitrification catalyst, i.e., 1% PdCu-AC prepared above, is suspended in the electrolyte solution. The electrochemical workstation CH1760D electrically connected to the three-electrode system is started to perform the denitrification reaction for 5 h. The denitrification effect is shown in FIG. 5, wherein, the abscissa of FIG. 5 shows the denitrification catalyst with different metal supporting contents. The left ordinate is the proportion of reaction products, and the right ordinate is the nitrate removal rate.

### Embodiment 3

A denitrification system for efficiently removing nitrate in a water body by electrocatalytic hydrogen evolution and catalytic hydrogenation includes the electrolytic cell 1 and a three-electrode system inserted into the electrolytic cell 1.

The electrolytic cell 1 contains electrolyte solution, and the denitrification catalyst 11 is dispersed and suspended in the electrolyte solution. The denitrification catalyst 11 is an activated carbon PdCu-AC supported with metal palladium and copper, and the preparation steps of the PdCu-AC are as follows:

(1) 25 g of activated carbon powder is added to 500 ml of 10% dilute nitric acid, heated in water bath at 80° C. for 4 h, and then filtered by vacuum suction filtration to obtain a solid, and finally the solid is put in an oven for drying at 100° C. for 4 h to obtain a pretreated AC;

(2) 0.167 g of PdCl₂, 0.189 g of Cu(NO₃)₂.3H₂O and 1 g of the pretreated AC are added into 10 ml of ethanol and stirred evenly;

(3) the mixture obtained in step (2) is stirred at room temperature until the ethanol is evaporated, and the obtained solid is dried in the oven at 80° C. for 12 h;

(4) the product obtained in step (3) is placed in a tubular furnace, heated to 400° C. at a heating rate of 10° C./min under a nitrogen atmosphere and calcined for 2 h to obtain an activated carbon catalyst (10% PdCu-AC) supported with palladium and copper. The TEM image of the catalyst is shown in FIG. 4.

The three-electrode system includes the working electrode 21, the counter electrode 22 and the reference electrode 23, and the counter electrode 22 adopts Pt sheet, the working electrode 21 adopts the catalyst Ni₃S₂—NF, and the preparation steps of the catalyst Ni₃S₂—NF are as follows:

(1) a nickel mesh is cut to have a size of 2.5×2.5 cm, which is first ultrasonic cleaned with 30 ml of acetone for 10 min, and then ultrasonic cleaned with 30 ml of 3 M hydrochloric acid for 10 min, and finally washed with ethanol and deionized water for 3 times respectively;

(2) the cleaned nickel mesh in step (1) is added to 20 ml of O.15M thiourea solution and transferred to a reactor, and kept airtight for 5 h at 150° C.;

(3) Ni₃S₂—NF is obtained by washing the material obtained in step (2) three times with ethanol and vacuum drying at room temperature.

The above denitrification system is applied to the removal of nitrate in water, and the specific steps are as follows: 100 ml of solution containing sodium nitrate and sodium sulfate is used as electrolyte solution, the concentration of sodium nitrate in the electrolyte solution is 100 mg:N/L, and the concentration of sodium sulfate is 0.1 M, and 1 g of denitrification catalyst, i.e., 10% PdCu-AC prepared above, is suspended in the electrolyte solution, and the electrochemical workstation CH 760D electrically connected to the three-electrode system is started to perform denitrification reaction for 5 h, the denitrification effect is shown in FIG. 5, wherein, the abscissa of FIG. 5 shows the denitrification catalyst with different metal supporting contents, the left ordinate is the proportion of reaction products, and the right ordinate is the nitrate removal rate.

### Comparative Example 1

A denitrification system for removing nitrate in water body, includes the electrolytic cell 1 and a three-electrode system inserted into the electrolytic cell 1. The electrolytic cell 1 contains electrolyte solution, and the denitrification catalyst 11 is dispersed and suspended in the electrolyte solution. The denitrification catalyst 11 is an activated carbon AC. The three-electrode system includes the working electrode 21, the counter electrode 22 and the reference electrode 23. The counter electrode 22 adopts Pt sheet, the working electrode 21 adopts the catalyst Ni₃S₂—NF, and the preparation steps of the catalyst Ni₃S₂—NF are as follows:

(1) a nickel mesh is cut to have a size of 2.5×2.5 cm, which is first ultrasonic cleaned with 30 ml of acetone for 10 min, and then ultrasonic cleaned with 30 ml of 3 M hydrochloric acid for 10 min, and finally washed with ethanol and deionized w Tater for 3 times respectively;

(2) the cleaned nickel mesh in step (1) is added to 20 ml of 0.15M thiourea solution and transferred to a reactor, and kept airtight for 5 h at 150° C.;

(3) Ni₃S₂—NF is obtained by washing the material obtained in step (2) three times with ethanol and vacuum drying at room temperature.

The above denitrification system is applied to the removal of nitrate in water, and the specific steps are as follows: 100 ml of solution containing sodium nitrate and sodium sulfate is used as electrolyte solution, the concentration of sodium nitrate in the electrolyte solution is 100 mg:N/L, and the concentration of sodium sulfate is 0.1 M, and 1 g of AC is suspended in the electrolyte solution, and the electrochemical workstation CHI760D electrically connected to the three-electrode system is started to perform denitrification reaction for 5 h, the denitrification effect is shown in FIG. 5, wherein, the abscissa of FIG. 5 shows the denitrification catalyst with different metal supporting contents, the left ordinate is the proportion of reaction products, and the right ordinate is the nitrate removal rate.

By comparing the embodiments 1-3 with the comparative example 1, it can be seen that the activated carbon PdCu-AC supported with metal palladium and copper has a better denitrification effect than the activated carbon AC when using as the denitrification catalyst. PdCu-AC can achieve the optimal denitrification effect when the metal supporting content of PdCu-AC is 5%. The optimal denitrification effect obtained under this supporting content is attributed to the highly dispersed metal active components on the support, thus having sufficient catalytic active sites.

### Comparative Example 2

A denitrification system for removing nitrate in water body, includes the electrolytic cell 1 and a three-electrode system inserted into the electrolytic cell 1. The electrolytic cell 1 contains electrolyte solution, and the denitrification catalyst 11 is dispersed and suspended in the electrolyte solution, and the denitrification catalyst 11 is an activated carbon PdCu-AC supported with metal palladium and copper, and the PdCu-AC is prepared by the method in embodiment 1. The three-electrode system includes the working electrode 21, the counter electrode 22 and the reference electrode 23, and the counter electrode 22 adopts Pt sheet, the working electrode 21 adopts graphite carbon.

The above denitrification system is applied to the removal of nitrate in water, and the specific steps are as follows: 100 ml of solution containing sodium nitrate and sodium sulfate is used as electrolyte solution, the concentration of sodium nitrate in the electrolyte solution is 100 mg-N/L, and the concentration of sodium sulfate is 0.1 M, and 1 g of denitrification catalyst, i.e., 5% PdCu-AC, is suspended in the electrolyte solution, and the electrochemical workstation CHI760D 3 electrically connected to the three-electrode system is started to perform denitrification reaction for 5 h, the denitrification effect is shown in FIG. 8, wherein, the abscissa of FIG. 8 shows different working electrodes, the left ordinate is the proportion of reaction products, and the right ordinate is the nitrate removal rate.

### Comparative Example 3

A denitrification system for removing nitrate in water body, includes the electrolytic cell 1 and a three-electrode system inserted into the electrolytic cell 1. The electrolytic cell 1 contains electrolyte solution, and the denitrification catalyst 11 is dispersed and suspended in the electrolyte solution, and the denitrification catalyst 11 is an activated carbon PdCu-AC supported with metal palladium and copper, and the PdCu-AC is prepared by the method in embodiment 1. The three-electrode system includes the working electrode 21, the counter electrode 22 and the reference electrode 23, and the counter electrode 22 adopts Pt sheet, the working electrode 21 adopts nickel foam NF.

The above denitrification system is applied to the removal of nitrate in water, and the specific steps are as follows: 100 ml of solution containing sodium nitrate and sodium sulfate is used as electrolyte solution, the concentration of sodium nitrate in the electrolyte solution is 100 mg-N/L, and the concentration of sodium sulfate is 0.1 M, and 1 g of denitrification catalyst, i.e., 5% PdCu-AC, is suspended in the electrolyte solution, and the electrochemical workstation CHI760D 3 electrically connected to the three-electrode system is started to perform denitrification reaction for 5 h, the denitrification effect is shown in FIG. 8, wherein, the abscissa of FIG. 8 shows different working electrodes, the left ordinate is the proportion of reaction products, and the right ordinate is the nitrate removal rate.

By comparing the embodiment 1 with the comparative examples 1-2, the denitrification system can achieve the optimal denitrification effect when using Ni₃S₂—NF material instead of graphite carbon and NE as working electrode.

It can be understood that the above specific description of the invention is only used to illustrate the invention and is not limited to the technical solution described in the embodiment of the invention. Those of ordinary skill in the art should understand that the invention can still be modified or equivalently replaced in order to achieve the same technical effect; as long as the use needs are met, they are all within the protection scope of the invention.

What is claimed is:

1. A denitrification system for efficiently removing nitrate in a water body by electrocatalytic hydrogen evolution and catalytic hydrogenation, comprising an electrolytic cell and a three-electrode system inserted into the electrolytic cell, wherein the electrolytic cell contains an electrolyte solution, and the three-electrode system comprises a working electrode, a counter electrode and a reference electrode, and the counter electrode adopts a Pt sheet, a denitrification catalyst is dispersed and suspended in the electrolyte solution, the working electrode adopts a catalyst Ni₃S₂—NF, and preparation steps of the catalyst Ni₃S₂—NF are as follows:
(1) cutting and cleaning a nickel mesh to obtain a cleaned nickel mesh;
(2) adding the cleaned nickel mesh in step (1) into a thiourea solution to obtain a soaked nickel mesh, and then placing the soaked nickel mesh under hydrothermal conditions;
(3) washing and drying the soaked nickel mesh in step

2. The denitrification system according to claim 1, wherein the denitrification catalyst is PdCu-AC, and the PdCu-AC is an activated carbon supported with metal palladium and copper, and preparation steps of the PdCu-AC are as follows:
(1) adding an activated carbon into nitric acid to obtain a first mixture, heating the first mixture in a water bath, filtering the first mixture obtain a filtered substance and drying the filtered substance to obtain a pretreated activated carbon AC;
(2) adding the pretreated activated carbon AC, palladium chloride PdCl₂ and copper nitrate into ethanol to obtain a second mixture and stirring the second mixture evenly;
(3) stirring the second mixture obtained in step (2) at room temperature until the ethanol is evaporated to obtain a third mixture, and drying the third mixture to obtain powder;
(4) calcining the powder obtained in step (3) in a tubular furnace to obtain the PdCu-AC.

3. The denitrification system according to claim 2, wherein the nitric acid in step (1) is 10%-45% dilute nitric acid, a temperature of the water bath is 60-100° C., the heating lasts for 4-6 h, the filtering is performed by a vacuum suction filtration, and the drying is performed at 100-120° C. for 2-4 h.

4. The denitrification system according to claim 2, wherein the copper nitrate in step (2) is copper nitrate trihydrate Cu(NO₃)₂.3H₂O, and a mass ratio of the AC, the PdCl₂ and the Cu(NO₃)₂.3H₂O is 1: (0.0835-0.167):(0.0945-0.189).

5. The denitrification system according to claim 2, wherein the drying described in step (3) is performed in an oven at 60-100° C. for 10-12 h.

6. The denitrification system according to claim 2, wherein the calcining in step (4) is carried out in the tubular furnace under a nitrogen atmosphere, and a temperature is raised to 400° C. at a heating rate of 1° C./min for 2-4 h.

7. The denitrification system according to claim 1, wherein the cleaning of the nickel mesh in step (1) is as follows: ultrasonic cleaning the nickel mesh in 30 ml of acetone and 30 ml of hydrochloric acid for 10-15 min in turn, and then cleaning the nickel mesh three times with ethanol and water respectively.

8. The denitrification system according to claim 1, wherein a concentration of the thiourea solution in step (2) is 0.10-0.20 M, a hydrothermal temperature is 120-150° C., and a hydrothermal time is 4-6 h.

9. The denitrification system according to claim 1, wherein the washing described in step (3) is to wash the soaked nickel mesh three times with ethanol, and the drying is a vacuum drying at room temperature.

10. A method of using the denitrification system according to claim 1 in a removal of nitrate from the water body, comprising:
dispersing and suspending 1 g of the denitrification catalyst in 100 ml of the electrolyte solution, and
starting an electrochemical workstation electrically connected to the three-electrode system for a reaction for 5 h;
wherein the electrolyte solution is a solution containing sodium nitrate and sodium sulfate, a concentration of the sodium nitrate in the electrolyte solution is 100 mg-N/L, a concentration of the sodium sulfate in the electrolyte solution is 0.1 M.

11. The method according to claim 10, wherein the denitrification catalyst is PdCu-AC, and the PdCu-AC is an activated carbon supported with metal palladium and copper, and preparation steps of the PdCu-AC are as follows:
(1) adding an activated carbon into nitric acid to obtain a first mixture, heating the first mixture in a water bath, filtering the first mixture obtain a filtered substance and drying the filtered substance to obtain a pretreated activated carbon AC;
(2) adding the pretreated activated carbon AC, palladium chloride PdCl₂ and copper nitrate into ethanol to obtain a second mixture and stirring the second mixture evenly;
(3) stirring the second mixture obtained in step (2) at room temperature until the ethanol is evaporated to obtain a third mixture, and drying the third mixture to obtain powder;
(4) calcining the powder obtained in step (3) in a tubular furnace to obtain the PdCu-AC.

12. The method according to claim 11, wherein the nitric acid in step (1) is 10%-15% dilute nitric acid, a temperature of the water bath is 60-100° C., the heating lasts for 4-6 h, the filtering is performed by a vacuum suction filtration, and the drying is performed at 100-120° C. for 2-4 h.

13. The method according to claim 11, wherein the copper nitrate in step copper nitrate trihydrate Cu(NO₃)₂.3H₂O, and a mass ratio of the AC, the PdCl₂ and the Cu(NO₃)₂.3H₂O is 1: (0.0835-0.167):(0.0945-0.189).

14. The method according to claim 11, wherein the drying described in step (3) is performed in an oven at 60-100° C. for 10-12 h.

15. The method according to claim 11, wherein the calcining in step (4) is carried out in the tubular furnace under a nitrogen atmosphere, and a temperature is raised to 400° C.. at a heating rate of 1° C./min for 2-4 h.

16. The method according to claim 10, wherein the cleaning of the nickel mesh in step (1) is as follows: ultrasonic cleaning the nickel mesh in 30 ml of acetone and 30 ml of hydrochloric acid for 10-15 min in turn, and then cleaning the nickel mesh three times with ethanol and water respectively.

17. The method according to claim 10, wherein a concentration of the thiourea solution in step (2) is 0.10-0.2.0 M, a hydrothermal temperature is 120-150° C., and a hydrothermal time is 4-6 h.

18. The method according to claim 10, wherein the washing described in step (3) is to wash the soaked nickel mesh three times with ethanol, and the drying is a vacuum drying at room temperature.
